(19) United States
(12) Patent Application Publication
(10) Pub. No.: US 2004/0009317 A1
(43) Pub. Date: Jan. 15, 2004

(54) Hose

(75) Inventor: Ayumu Ikemoto, Komaki-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: TOKAI RUBBER INDUSTRIES, LTD., Komaki-shi (JP)

(21) Appl. No.: 10/614,786

(22) Filed: Jul. 9, 2003

(30) Foreign Application Priority Data
Jul. 12, 2002 (JP) JP2002-204405

(51) Int. Cl. B32B 1/08

(52) U.S. Cl. 428/36.91

(57) ABSTRACT

A hose having strong adhesion between a reinforcing fiber layer and a rubber layer without the use of an adhesive and which has an excellent sealing property. The hose has a laminated structure of a rubber layer 1, 3 and a reinforcing fiber layer 2, wherein the rubber layer is produced from the following components (A) to (E):

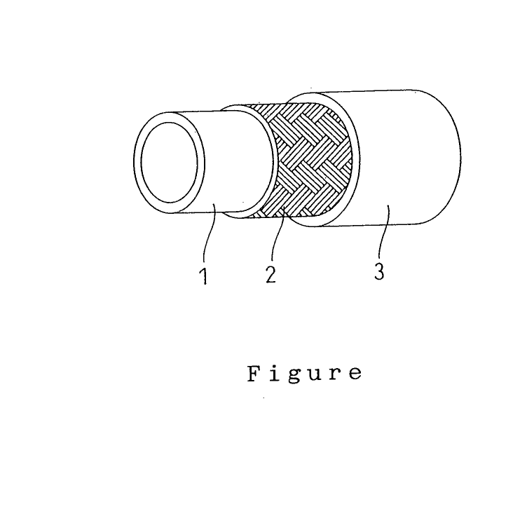

(A) a rubber comprising at least one of an ethylene-propylene-diene terpolymer and an ethylene-propylene copolymer;

(B) a peroxide crosslinking agent;

(C) a resorcinol compound;

(D) a melamine resin; and

(E) an epoxy resin.

### BACKGROUND OF THE INVENTION

The present invention relates to hoses having a laminated structure of a rubber layer and a reinforcing fiber layer, more particularly, to engine cooling hoses such as a radiator hose for connection between an engine and a radiator and a heater hose for connection between an engine and a heater core, refrigerant conveying hoses such as used in a cooler, fuel cell automobile hoses such as a methanol fuel hose and a hydrogen fuel hose, and automobile hoses such as a gasoline fuel hose.

### DESCRIPTION OF THE ART

Conventionally, as automotive engine cooling hoses such as a radiator hose for connection between an engine and a radiator and a heater hose for connection between an engine and a heater core, for example, a hose having a three-layer structure (an inner rubber layer/a reinforcing fiber layer/an outer rubber layer) has been used. Such a hose is produced by forming the reinforcing fiber layer on an outer peripheral surface of the inner rubber layer and then forming the outer rubber layer on an outer peripheral surface of the reinforcing fiber layer. Specifically, such a hose is produced, for example, by extruding a material for forming the inner rubber layer, knitting reinforcing fibers such as a nylon fiber or an aramid fiber on an outer peripheral surface thereof for forming the reinforcing fiber layer, applying an adhesive on an outer peripheral surface thereof, and extruding a material for the outer rubber layer for forming the outer rubber layer, and then vulcanizing the thus obtained product. To improve adhesion between the respective layers, an adhesive may be applied in the interface between the inner rubber layer and the reinforcing fiber layer. Alternatively, a dip-coated fiber treated by dipping into an adhesive may be used.

However, since the reinforcing fiber layer and the rubber layer are bonded by an adhesive in the above-mentioned conventional hose, the adhesion between the reinforcing fiber layer and the rubber layer may be insufficient due to uneven application of the adhesive, resulting in a problem of a poor sealing property. Furthermore, with the need for an adhesive application step, the production process is complicated and more costly. In addition, consideration should be given to the pot life and concentration control for the adhesive, making it difficult to ensure stable production. Further, the production process presents various problems associated with environmental pollution because an organic solvent such as toluene is employed as a thinner for the adhesive.

In view of the foregoing, it is an object of the present invention to provide a hose having strong adhesion between a reinforcing fiber layer and a rubber layer without the use of an adhesive and which has an excellent sealing property.

### SUMMARY OF THE INVENTION

In accordance with the present invention and to achieve the aforesaid object, there is provided a hose having a laminated structure of a rubber layer and a reinforcing fiber layer, wherein the rubber layer is produced by using the following components (A) to (E):

(A) a rubber comprising at least one of an ethylene-propylene-diene terpolymer and an ethylene-propylene copolymer;

(B) a peroxide crosslinking agent;

(C) a resorcinol compound;

(D) a melamine resin; and

(E) an epoxy resin.

The inventor found that when specific adhesive components (a resorcinol compound and a melamine resin) were kneaded into a rubber material such as ethylene-propylene-diene terpolymer (EPDM), and these components were vulcanized using a peroxide crosslinking agent, superior adhesion between the rubber and a material to be adhered thereto could be achieved without the use of an adhesive (in a so-called adhesiveless production process), and thus filed a patent application in Japan (Patent Application No. JP2001-017536). However, as a result of further research and development on this rubber composition, the inventor found that in the case of the hose having a laminated structure comprising a rubber layer and a reinforcing fiber layer, the adhesion with the reinforcing fiber layer, especially, the reinforcing fiber layer using an aramid fiber, may be insufficient, as there may be a possibility of deterioration of quality or adhesion of the hose due to sliding of the reinforcing fiber. Then, the inventor conducted further research and development for obtaining a hose superior in the adhesion between the rubber layer and the reinforcing fiber layer. Among other things, the inventor determined that when an epoxy resin as well as a resorcinol compound and a melamine resin were kneaded into a rubber material such as ethylene-propylene-diene terpolymer, and these components are vulcanized using a peroxide crosslinking agent, superior adhesion between the rubber layer and the reinforcing fiber layer could be achieved and a hose having an excellent sealing property could be obtained. Thus, the present invention was realized.

A reason the rubber layer composed of the aforesaid specific rubber composition has excellent adhesion to the reinforcing fiber layer is believed to be as follows. The resorcinol compound mainly functions as an adhesive, and the melamine resin mainly functions as an auxiliary adhesive agent. More specifically, the melamine resin donates CH₂O to the resorcinol compound, which in turn forms covalent bonds with the reinforcing fiber thereby to improve the adhesion. For example, the melamine resin donates CH₂O to a resorcinol compound represented by the following formula (C) to provide a compound represented by the following formula (C′), which in turn forms covalent bonds with the reinforcing fiber to ensure firm adhesion. In addition, hydroxyl groups of the resorcinol compound partly serve for hydrogen bonding with the reinforcing fiber. It is supposed that the hydrogen bonding also contributes to the improvement of the adhesive effect. Further, since the epoxy resin is used with the resorcinol compound and the melamine resin, intermolecular force is increased between the rubber and the reinforcing fiber, which in turn improves adhesion.

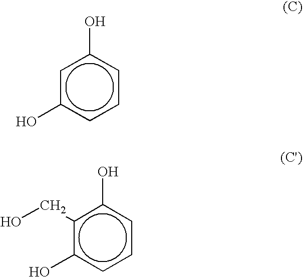

### BRIEF DESCRIPTION OF THE DRAWING

The sole figure of the drawing is a perspective view showing one embodiment of a hose according to the present invention.

### DESCRIPTION OF THE PREFERRED EMBODIMENTS

The present invention will now be described in greater detail and with regard to preferred embodiments.

An inventive hose may have a laminated structure of two or more layers including a specific rubber layer and a reinforcing fiber layer. For example, the hose may comprise a three-layer structure of a specific rubber layer (an inner rubber layer), a reinforcing fiber layer, and a specific rubber layer (an outer rubber layer).

The rubber layer comprises: (A) a specific rubber; (B) a peroxide crosslinking agent; (C) a resorcinol compound; (D) a melamine resin; and (E) an epoxy resin.

At least one of an ethylene-propylene-diene terpolymer (EPDM) and an ethylene-propylene copolymer (EPM) is employed as the specific rubber (A). The EPDM is not particularly limited as long as it is generally used as a base material for rubber compositions. However, it is preferred that the EPDM has an iodine value of 6 to 30, particularly 10 to 24, and an ethylene ratio of 48 to 70 wt %, particularly 50 to 60 wt %, of the specific rubber (A).

A diene monomer (third component) in the EPDM is not particularly limited, but preferably is a diene monomer having a carbon number of 5 to 20. Specific examples of the diene monomer include 1,4-pentadiene, 1,4-hexadiene, 1,5-hexadiene, 2,5-dimethyl-1,5-hexadiene, 1,4-octadiene, 1,4-cyclohexadiene, cyclooctadiene, dicyclopentadiene (DCP), 5-ethylidene-2-norbornene (ENB), 5-butylidene-2-norbornene, 2-methallyl-5-norbornene and 2-isopropenyl-5-norbornene. Among these diene monomers (third component), dicyclopentadiene (DCP) and 5-ethylidene-2-norbornene (ENB) are particularly preferred.

Examples of the peroxide crosslinking agent (B) to be used in combination with the specific rubber (A) include 2,4-dichlorobenzoyl peroxide, benzoyl peroxide, 1,1-di-t-butylperoxy-3,3,5-trimethylcyclohexane, 2,5-dimethyl-2,5-dibenzoylperoxyhexane, n-butyl-4,4′-di-t-butylperoxyvalerate, dicumyl peroxide, t-butylperoxybenzoate, di-t-butylperoxy-diisopropylbenzene, t-butylcumyl peroxide, 2,5-dimethyl-2,5-di-t-butylperoxyhexane, di-t-butyl peroxide and 2,5-dimethyl-2,5-di-t-butylperoxyhexyne-3, which may be used either alone or in combination. Among these peroxide crosslinking agents, di-t-butylperoxy-diisopropylbenzene is particularly preferred, because it is free from a problem associated with smell.

The peroxide crosslinking agent (B) is preferably present in the rubber composition in a proportion of 1.5 to 20 parts by weight (hereinafter referred to simply as “parts”) based on 100 parts of the rubber (A). If the proportion of the component (B) is smaller than 1.5 parts, the resulting hose tends to have a lower strength because of insufficient crosslinking of the rubber. If the proportion of the component (B) is greater than 20 parts, the resulting hose tends to have poorer flexibility with a higher hardness of the rubber.

The resorcinol compound (C) to be used in combination with the components (A) and (B) is not particularly limited, as long as it serves as an adhesive. Examples of the resorcinol compound include modified resorcin-formaldehyde resins, resorcin and resorcin-formaldehyde (RF) resins, which may be used either alone or in combination. Among these resorcinol compounds, the modified resorcin-formaldehyde resins are particularly preferred in terms of evaporability, moisture absorption and compatibility with the rubber.

Examples of the modified resorcin-formaldehyde resins include resins represented by the following general formulae (1) to (3), among which resins represented by the general formula (1) are particularly preferred.

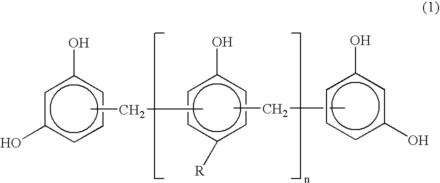

(wherein R is a hydrocarbon group, and n is 0 or a positive number)

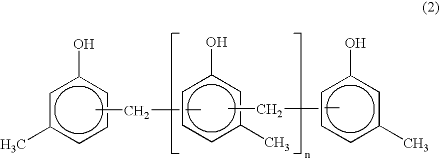

(wherein n is 0 or a positive number)

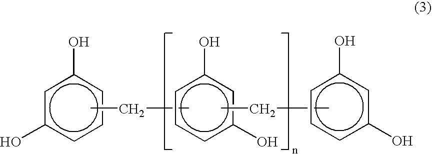

(wherein n is 0 or a positive number)

In the aforesaid general formulae (1) to (3), n represents 0 or a positive number, among which a number in the range of 0 to 3 is preferred.

The resorcinol compound (C) is preferably present in the rubber composition in a proportion of 0.1 to 10 parts, particularly preferably 0.5 to 5 parts, based on 100 parts of the rubber (A). If the proportion of the component (C) is smaller than 0.1 part, the resulting rubber layer tends to have poorer adhesion to the reinforcing fiber. On the other hand, if the proportion of the component (C) is greater than 10 parts, the cost is increased.

The melamine resin (D) to be used in combination with the components (A) to (C) is not particularly limited, as long as it serves as an auxiliary adhesive agent. Examples of the melamine resin include methylated formaldehyde-melamine polymers and hexamethylenetetramine, which may be used either alone or in combination. Among these melamine resins, methylated formaldehyde-melamine polymers are particularly preferred in terms of evaporability, moisture absorption and compatibility with the rubber.

Examples of methylated formaldehyde-melamine polymers include polymers represented by the following general formula (4).

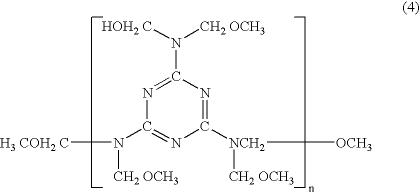

(wherein n is a positive number)

In the aforesaid general formula (4), n represents a positive number, among which a number of 1 to 3 is preferred.

A mixture of the methylated formaldehyde-melamine polymers represented by the general formula (4) is preferably used as the melamine resin (D). It is particularly preferred that the mixture contains methylated formaldehyde-melamine polymers of the general formula (4) wherein n=1, n=2 and n=3 in proportions of 43 to 44 wt %, 27 to 30 wt % and 26 to 30 wt %, respectively.

The resorcinol compound (C) and the melamine resin (D) are preferably present in the rubber composition in a weight ratio of C/D=1/0.5 to 1/2, particularly preferably C/D=1/0.77 to 1/1.5. If the weight ratio of the component (D) is lower than 0.5, the resulting rubber layer has slightly deteriorated steady-state properties with a lower tensile strength (TB) and a lower extensibility (EB). If the weight ratio of the component (D) is higher than 2, the adhesion property plateaus with a constant adhesion strength. Therefore, further increase in the weight ratio of the component (D) leads to a cost increase with no additional effect in terms of adhesion property.

The epoxy resin (E) to be used in combination with the components (A) to (D) is not particularly limited. Examples thereof include those of glycidyl amine epoxy resin, triphenyl glycidyl methane epoxy resin, tetraphenyl glycidyl methane epoxy resin, amino phenol epoxy resin, diamido diphenyl methane epoxy resin, phenol novolak epoxy resin, orthocresol epoxy resin, bisphenol A novolak epoxy resin and glycidyl ether epoxy resin, which may be used either alone or in combination.

The epoxy resin (E) is preferably present in the rubber composition in a proportion of 1 to 20 parts, particularly preferably 3 to 10 parts, based on 100 parts of the rubber (A). If the proportion of the component (E) is smaller than 1 part, adhesion between the specific rubber layer and the reinforcing fiber layer is not sufficiently improved. On the other hand, if the proportion of the component (C) is greater than 20 parts, heat resistance or a sealing property at a high temperature may be deteriorated.

In addition to the aforesaid components (A) to (E), carbon black, a process oil and the like preferably are blended in the rubber composition.

In addition to the aforesaid components, any one or more of various additives such as antioxidants, processing aids, crosslinking accelerators, white fillers, reactive monomers and foaming agents may be blended in the rubber composition, as required.

The reinforcing fiber for forming the reinforcing fiber layer is not specifically limited. Examples thereof include aramid (aromatic polyamide) fibers, nylon (polyamide) fibers such as nylon 6 and nylon 66, rayon fibers and polyester fibers, which may be used either alone or in combination. Among these reinforcing fibers, aramid fibers are preferably used in terms of superior heat resistance.

The knitting method of the reinforcing fiber is not specifically limited. Examples thereof include spiral methods and braiding methods.

The method of producing the hose according to the present invention will specifically be described with reference to the figure. The rubber composition for forming the specific rubber layer may be prepared by mixing the components (A) to (E) and, as required, any of the aforesaid additional components, and kneading the resulting mixture by means of a kneading machine such as a mixing roll, a kneader or a Banbury mixer. After extruding the rubber composition into a hose configuration, a reinforcing fiber may be spirally wound on an outer peripheral surface of the rubber composition inner layer directly without use of an adhesive (in a so-called adhesiveless production process) so as to form a reinforcing fiber layer 2. Successively, the rubber composition is extruded on an outer peripheral surface of the reinforcing fiber layer 2 without use of an adhesive, and the thus obtained product is heated under specific conditions. As a result, the reinforcing fiber layer 2 is integrally formed onto an outer peripheral surface of the inner rubber layer 1 and the outer rubber layer 3 is integrally formed onto an outer peripheral surface of the reinforcing fiber layer 2. The resultant hose has a three-layer structure (the inner rubber layer 1/the reinforcing fiber layer 2/the outer rubber layer 3), as shown in the figure.

The dimension of the thus obtained hose is not specifically limited, but the hose typically has an outer diameter of 8 to 50 mm and the total thickness (wall thickness) of 1.8 to 6 mm. In the hose thus produced, the thickness of each layer is also not specifically limited as long as the function of each layer can be sufficiently realized. For example, the inner rubber layer 1 typically has a thickness of 1 to 4 mm and the outer rubber layer 3 typically has a thickness of 0.8 to 2 mm.

In the present invention, the inner rubber layer 1 and the outer rubber layer 3 are not necessarily produced by using the above components (A) to (E). Either of the inner rubber layer 1 or the outer rubber layer 3 may be formed by using a rubber composition comprising a general-purpose rubber material containing one or more components other than the above components (A) to (E).

The structure of the inventive hose is not limited to a three layer structure (an inner rubber layer 1/a reinforcing fiber layer 2/an outer rubber layer 3), as shown in the figure. Also contemplated are multi-layer structures having a two or more layers including the specific rubber layer and the reinforcing fiber layer.

The use of the thus obtained hose is not specifically limited. For example, the inventive hose is applicable to engine cooling hoses such as a radiator hose for connection between an engine and a radiator. The inventive hose also is applicable to heater hoses for connection between an engine and a heater core, refrigerant conveying hoses such as used in a cooler, fuel cell automobile hoses such as a methanol fuel hose and a hydrogen fuel hose, and automobile hoses such as a gasoline fuel hose. Where the inventive hose is employed as a gasoline fuel hose, the specific rubber layer is preferably provided as a layer (e.g., outer layer) other than the innermost layer, because EPDM or EPM has a relatively poor gasoline resistance.

Next, descriptions will be given to Examples and Comparative Examples.

Prior to the explanation of Examples and Comparative Examples, the components employed herein will be detailed below.

EPDM—Component (A)

EPDM (ESPRENE 501A available from Sumitomo Chemical Co., Ltd., and having an iodine value of 12, an ethylene ratio of 50 wt % and a Mooney viscosity (ML1+4 100° C.) of 43)

EPM—Component (A)

EPM (ESPRENE 201 available from Sumitomo Chemical Co., Ltd.)

Peroxide Crosslinking Agent—Component (B)

Di-t-butylperoxy-diisopropylbenzene (PEROXYMON F-40 available from NOF Corporation)

Resorcinol Compound—Component (C)

Modified resorcin-formaldehyde resin represented by the general formula (1) (SUMIKANOL 620 available from Sumitomo Chemical Co., Ltd.)

Melamine Resin—Component (D)

Methylated formaldehyde-melamine polymer (SUMIKANOL 507A available from Sumitomo Chemical Co., Ltd.)

Epoxy Resin—Component (E)

Bisphenol A epoxy resin (Epikote 828 available from Japan Epoxy Resins Co., Ltd.)

Carbon Black

SEAST SO available from Tokai Carbon Co.

Process Oil

Diana Process Oil PW-380 available from Idemitsu Kosan Co., Ltd.

Vulcanization Accelerator 1

Tetramethylthiuram disulfide (SANCELER TT available from Sanshin Chemical Co., Ltd.)

Vulcanization Accelerator 2

Zinc dimethyldithiocarbamate (SANCELER PZ available from Sanshin Chemical Co., Ltd.)

Vulcanization Accelerator 3

Mercaptobenzothiazole (SANCELER M available from Sanshin Chemical Co., Ltd.)

Crosslinking Agent

Sulfur

### EXAMPLE 1

The components were each mixed as shown in the following Table 1 and were kneaded by means of a roll for preparation of each rubber composition. The rubber composition thus prepared was extruded, and then a reinforcing fiber (an aramid fiber) was spirally wound on an outer peripheral surface of the rubber layer by means of a braiding machine for formation of a reinforcing fiber layer. Then, the aforesaid rubber composition was extruded on an outer peripheral surface of the reinforcing fiber layer. The resulting hose structure was heated at 160° C. for 45 minutes. Thus, a hose (having an inner diameter of 27 mm) was produced, which included an inner rubber layer (having a thickness of 2 mm), the reinforcing fiber layer integrally provided on the outer peripheral surface of the inner rubber layer, and the outer rubber layer (having a thickness of 2 mm) integrally provided on the outer peripheral surface of the reinforcing fiber layer.

### EXAMPLES 2 to 6

The components were each mixed as shown in the following Table 1 and were kneaded by means of a roll for preparation of each rubber composition. Hoses were produced in substantially the same manner as in Example 1 by employing the thus obtained rubber compositions. In Example 6, a nylon fiber (nylon 66) was employed instead of the aramid fiber as the reinforcing fiber.

### COMPARATIVE EXAMPLE 1

The rubber composition was prepared in substantially the same manner as in Example 1, except that the resorcinol compound, melamine resin and epoxy resin were not included. The hose was produced in substantially the same manner as in Example 1 by employing the thus obtained rubber composition.

### COMPARATIVE EXAMPLE 2

Hoses were produced in substantially the same manner as in Comparative Example 1, except that an adhesive (EPDM rubber adhesive) was applied in the interface between the reinforcing fiber layer and the outer rubber layer.

### COMPARATIVE EXAMPLES 3 and 4

The components were each mixed as shown in the following Table 2 and were kneaded by means of a roll for preparation of each rubber composition. The hose was produced in substantially the same manner as in Example 1 by employing the thus obtained rubber composition.

Properties of the hoses thus produced in accordance with Examples and Comparative Examples were evaluated in the following manners. The results of the evaluations are shown in Tables 1 and 2.

Tensile Strength (TB) and Extension (EB)

The rubber compositions were each press-vulcanized at 160° C. for 45 minutes for preparation of a vulcanized rubber sheet having a thickness of 2 mm, and then stamped to provide a JIS No. 5 dumbbell specimen. The tensile strength (TB) and extension (EB) of the specimen were determined in conformity with Japanese Industrial Standard K 6251 (hereinafter Japanese Industrial Standard abbreviated as “JIS”). The higher are the values of the TB and the EB, the better is the quality.

Adhesion Property

A specimen of a laminated structure comprising a reinforcing fiber layer and a rubber layer (an outer rubber layer) for evaluation of adhesion properties was cut out of each of the hoses. The specimen was mounted on a tensile tester (JIS B 7721), and pulled from a reinforcing fiber layer side thereof at a rate of 50 mm/min with the outer rubber layer fixed to the tester for the evaluation of the adhesion property (kg/25 mm). Further, a broken state of the reinforcing fiber layer and the rubber layer was visually observed. For the evaluation of the broken state in Tables 1 and 2, a symbol ◯ indicates that the rubber layer was broken, and a symbol x indicates that interfacial separation occurred between the reinforcing fiber layer and the rubber layer.

Sealing Property

Metal caps were installed into opposite ends of each of the hoses. Then, coolant (LLC) was supplied into the hose. When the pressure of 0.2 MPa was applied on the coolant inside the hose from one end of the hose, leaking was visually evaluated for the sealing property. In Tables 1 and 2, the results of the evaluation for the sealing property are expressed by a symbol ◯ which indicates that the leaking of coolant was not observed, and a symbol Δ which indicates that coolant oozed around the metal cap at another end of the hose, and a symbol x which indicates that coolant leaked.

TABLE 1
(Parts by weight)

| | Example | | | | | |
|---|---|---|---|---|---|---|
| | 1 | 2 | 3 | 4 | 5 | 6 |
| Rubber layer | | | | | | |
| EPDM | 100 | 100 | 100 | 100 | — | 100 |
| EPM | — | — | — | — | 100 | — |
| Peroxide | 4.2 | 4.2 | 4.2 | 4.2 | 4.2 | 4.2 |
| crosslinking agent | | | | | | |
| Resorcinol | 1 | 1 | 1 | 5 | 1 | 1 |
| compound | | | | | | |
| Melamine resin | 0.77 | 0.77 | 0.77 | 3.85 | 0.77 | 0.77 |
| Epoxy resin | 5 | 1 | 20 | 5 | 5 | 5 |
| Carbon black | 100 | 100 | 100 | 100 | 100 | 100 |
| Process oil | 60 | 60 | 60 | 60 | 60 | 60 |
| Reinforcing | | | | | | |
| fiber layer | | | | | | |
| Reinforcing fiber | aramid | aramid | aramid | aramid | aramid | nylon |
| | fiber | fiber | fiber | fiber | fiber | fiber |
| TB (MPa) | 13.0 | 13.0 | 12.8 | 10.5 | 7.5 | 13.0 |
| EB (%) | 250 | 250 | 250 | 250 | 450 | 450 |
| Application of an | No | No | No | No | No | No |
| adhesive | | | | | | |
| Adhesion | 3.0 | 2.8 | 3.4 | 3.3 | 3.0 | 4.5 |
| (kg/25 mm) | | | | | | |
| Broken state | ◯ | ◯ | ◯ | ◯ | ◯ | ◯ |
| Sealing property | ◯ | ◯ | ◯ | ◯ | ◯ | ◯ |

TABLE 2
(Parts by weight)

| Comparative Example | | | |
|---|---|---|---|
| 1 | 2 | 3 | 4 |

Rubber layer

| | | | | |
|---|---|---|---|---|
| EPDM | 100 | 100 | 100 | 100 |
| EPM | — | — | — | — |
| Peroxide | 4.2 | 4.2 | — | 4.2 |
| crosslinking agent | | | | |
| Resorcinol compound | — | — | 1 | 1 |
| Melamine resin | — | — | 0.77 | 0.77 |
| Epoxy resin | — | — | — | — |
| Carbon black | 100 | 100 | 100 | 100 |
| Process oil | 60 | 60 | 60 | 60 |
| Vulcanization | — | — | 0.75 | — |
| accelerator 1 | | | | |
| Vulcanization | — | — | 0.75 | — |
| accelerator 2 | | | | |
| Vulcanization | — | — | 0.5 | — |
| accelerator 3 | | | | |
| Crosslinking agent | — | — | 1.5 | — |

Reinforcing fiber layer

| | aramid | aramid | aramid | aramid |
|---|---|---|---|---|
| Reinforcing fiber | fiber | fiber | fiber | fiber |
| TB (MPa) | 14.0 | 14.0 | 13.3 | 13.0 |
| EB (%) | 260 | 260 | 500 | 250 |
| Application of an | No | Yes | No | No |
| adhesive | | | | |
| Adhesion (kg/25 mm) | 0.1 | 1.5 | 0.2 | 2.3 |
| Broken state | x | x | x | x |
| Sealing property | x | x | x | Δ |

As can be understood from the results shown in Tables 1 and 2, the hoses of the Examples each had superior adhesion between the rubber layer and the reinforcing fiber layer and had a superior sealing property, because the rubber layer was broken. Further, tensile strength (TB) and extensibility (EB) of the hoses of the Examples each were approximately the same as those of Comparative Example 1 which did not contain the adhesive components (a resorcinol compound, a melamine resin and an epoxy resin), inherent rubber properties were not deteriorated even if the adhesive components were mixed therein.

In contrast, the hose of Comparative Example 1 had extremely poor adhesion between the rubber layer and the reinforcing fiber layer and had a poor sealing property, because the rubber layer did not contain the adhesive components (a resorcinol compound, a melamine resin and an epoxy resin). The hose of Comparative Example 2 had lower adhesion and suffered from interfacial separation, and had a poor sealing property compared with the Examples, in spite of the that an adhesive was applied in the interface between the reinforcing fiber layer and the outer rubber layer. The hose of Comparative Example 3 had lower adhesion and suffered from interfacial separation, and had a poor sealing property compared with the Examples. This may be due to the rubber layer being composed of a rubber composition containing a sulfur crosslinking agent instead of a peroxide crosslinking agent, because the sulfur crosslinking agent has a higher vulcanization rate than the peroxide crosslinking agent. Thus, the rubber layer per se may be vulcanized before the rubber layer is bonded to the reinforcing fiber layer thereby resulting in relatively poor adhesion. The hose of Comparative Example 4 had slightly low adhesion and had a slightly poor sealing property compared with the Examples, because the rubber layer was composed of the rubber composition containing a resorcinol compound and a melamine resin but not including an epoxy resin.

As described above, since the inventive hose is produced by kneading specific adhesive components (a resorcinol compound, a melamine resin and an epoxy resin) into a rubber material such as ethylene-propylene-diene terpolymer (EPDM), and vulcanizing these components using a peroxide crosslinking agent, superior adhesion between the rubber layer and the reinforcing fiber layer could be achieved without an adhesive. As a result, fibers may be difficult to slip out of the reinforcing fiber layer and rate of change in the outer diameter of the hose can be lowered. Therefore, a gap between a hose and a pipe or the like may be bridged, resulting in an extremely improved sealing property.

Without the need for the adhesive applying step, there is no need to give consideration to the pot life and concentration control of an adhesive, and thus a more stable production can be ensured. Without the use of an organic solvent as a thinner for the adhesive, there is no problem associated with environmental pollution from the solvent. Since vulcanization is carried out by employing the peroxide crosslinking agent instead of the conventional sulfur crosslinking agent, there is no need to blend zinc oxide in the rubber composition (a zinc-free production process can be realized). The hose is free from clogging or leakage of liquid from a seal portion.

When the epoxy resin (E) is present in the rubber composition in a ratio within the previously described range, adhesion between the rubber layer and the reinforcing fiber layer is further improved.

Further, when the reinforcing fiber layer is formed by the aramid fiber, the heat resistance of the hose is improved.

When the weight ratio of the resorcinol compound (C) and the melamine resin (D) is within the previously described range, adhesion between the rubber layer and the reinforcing fiber layer is further improved. When the resorcinol compound (C) is present in the rubber composition in a proportion within the previously described range based on the specific rubber (A), adhesion between the rubber layer and the reinforcing fiber layer is further improved.

What is claimed is:

1. A hose having a laminated structure of a rubber layer and a reinforcing fiber layer, wherein the rubber layer is produced from the following components (A) to (E):
(A) a rubber comprising at least one of an ethylene-propylene-diene terpolymer and an ethylene-propylene copolymer;
(B) a peroxide crosslinking agent;
(C) a resorcinol compound;
(D) a melamine resin; and
(E) an epoxy resin.

2. A hose as set forth in claim 1, wherein the component (E) is in a proportion of 1 to 20 parts by weight based on 100 parts by weight of the component (A).

3. A hose as set forth in claim 1, wherein the reinforcing fiber layer includes an aramid fiber.

4. A hose as set forth in claim 2, wherein the reinforcing fiber layer includes an aramid fiber.

5. A hose as set forth in claim 1, wherein the components (C) and (D) are in a weight ratio of (C)/(D)=1/0.5 to 1/2.

6. A hose as set forth in claim 2, wherein the components (C) and (D) are in a weight ratio of (C)/(D)=1/0.5 to 1/2.

7. A hose as set forth in claim 3, wherein the components (C) and (D) are in a weight ratio of (C)/(D)=1/0.5 to 1/2.

8. A hose as set forth in claim 4, wherein the components (C) and (D) are in a weight ratio of (C)/(D)=1/0.5 to 1/2.

9. A hose as set forth in claim 1, wherein the component (C) is in a proportion of 0.1 to 10 parts by weight based on 100 parts by weight of the component (A).

10. A hose as set forth in claim 2, wherein the component (C) is in a proportion of 0.1 to 10 parts by weight based on 100 parts by weight of the component (A).

11. A hose as set forth in claim 3, wherein the component (C) is in a proportion of 0.1 to 10 parts by weight based on 100 parts by weight of the component (A).

12. A hose as set forth in claim 4, wherein the component (C) is in a proportion of 0.1 to 10 parts by weight based on 100 parts by weight of the component (A).

13. A hose as set forth in claim 5, wherein the component (C) is in a proportion of 0.1 to 10 parts by weight based on 100 parts by weight of the component (A).

14. A hose as set forth in claim 6, wherein the component (C) is in a proportion of 0.1 to 10 parts by weight based on 100 parts by weight of the component (A).

15. A hose as set forth in claim 7, wherein the component (C) is in a proportion of 0.1 to 10 parts by weight based on 100 parts by weight of the component (A).

16. A hose as set forth in claim 8, wherein the component (C) is in a proportion of 0.1 to 10 parts by weight based on 100 parts by weight of the component (A).
